(19) United States
(12) Patent Application Publication
(10) Pub. No.: US 2022/0028109 A1
(43) Pub. Date: Jan. 27, 2022

(54) IMAGE PROCESSING METHOD AND APPARATUS

(71) Applicant: SAMSUNG ELECTRONICS CO., LTD., Suwon-si (KR)

(72) Inventor: Dongwoo KANG, Seoul (KR)

(73) Assignee: SAMSUNG ELECTRONICS CO., LTD., Suwon-si (KR)

(21) Appl. No.: 17/224,748

(22) Filed: Apr. 7, 2021

(51) Int. Cl. G06T 7/73; G06K 9/00; G06K 9/03

(52) U.S. Cl. CPC G06T 7/74; G06T 2207/30201; G06K 9/03; G06K 9/00228

(57) ABSTRACT

An image processing method and apparatus are provided. The image processing method includes obtaining an image frame including a face of a user, detecting a face area of the user in the image frame, classifying a type of an occlusion of the face area based on whether the occlusion is present in at least a portion of the face area, tracking an eye of the user based on the type of the occlusion, and outputting information about the face area including a position of the tracked eye.

### CROSS-REFERENCE TO RELATED APPLICATION

This application claims priority to Korean Patent Application No. 10-2020-0093297, filed on Jul. 27, 2020, in the Korean Intellectual Property Office, the disclosure of which is incorporated by reference herein in its entirety.

### BACKGROUND

### 1. Field

Example embodiments of the disclosure relate to methods and apparatuses for processing an image.

### 2. Description of the Related Art

A camera-based eye tracking technology is used in various fields, such as, for example, a viewpoint tracking-based glasses-free three-dimensional (3D) super-multiview (SMV) display, a head-up display (HUD), and the like. In the camera-based eye tracking technology, performance may depend on a quality of an image captured by a camera and/or a method of eye tracking that is applied. The camera-based eye tracking technology works well on a bare face, but stability of an operation may decrease in a state of a partial area of a face is concealed or covered, for example, a state of wearing sunglasses or a hat when a person is driving a vehicle. Thus, there is a demand for an eye tracking method for stable operation even though a partial area of a face is covered, for instance, in consideration of an actual driving environment and in other areas utilizing camera-based eye tracking technology.

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

In accordance with an aspect of an example embodiment, there is provided an image processing method comprising: obtaining an image including a face of a user; detecting a face area of the user in the image; identifying a type of covering on the face area based on whether the covering is present in at least a portion of the face area; tracking an eye of the user based on the type of the covering; and outputting information about the face area including a position of the tracked eye.

The type of the covering may comprise at least one of: a first type corresponding to a bare face in which the covering is not present; a second type in which at least a portion of at least one of a forehead area, an eyebrow area, and an eye area in the face area is covered; a third type in which the eye area in the face area is covered; and a fourth type in which at least one of a nose area and a mouth area in the face area is covered.

The type of the covering may comprise at least one of: a first type corresponding to a bare face in which the covering is not present; and a second type in which an eye area in the face area is covered by sunglasses.

The tracking the eye of the user may comprise tracking the eye of the user by aligning different numbers of points in a shape of at least a portion of the face area based on the type of the covering.

The tracking the eye of the user may comprises: tracking the eye of the user by aligning a first number of points in a shape of a first portion of the face area, based on identifying that the type of the covering is the first type; and tracking the eye of the user by aligning a second number of points in a shape of a second portion of the face area, based on identifying that the type of the covering is one of the second type, the third type, or the fourth type, the second number being greater than the first number.

The tracking the eye of the user based on identifying that the type of the covering is the first type may comprise: reducing a size of a detection box used to detect the face area to correspond to a shape of an eye area and a shape of a nose area in the face area; obtaining a cropped portion comprising the eye area and the nose area by cropping the face area by the detection box reduced in size; and aligning the first number of points in the cropped portion, to track the eye of the user.

The tracking the eye of the user based on identifying the type of the covering is one of the second type, the third type, or the fourth type may comprise: aligning the second number of points in the shape of the second portion, which is an entire area of the face area, by a detection box used to detect the face area; and estimating a position of a pupil of the user from the face area by the second number of points, to track the eye of the user.

The tracking the eye of the user may comprises: redetecting the face area based on a failure in the tracking of the eye of the user using the aligned points; and repeatedly performing the identifying of the type of the covering and the tracking of the eye of the user, based on the redetected face area.

The identifying the type of the covering may comprise identifying the type of the covering using a classifier that is trained in advance to distinguish an area in which the covering is present from other areas in the face area by machine learning.

In accordance with an aspect of an example embodiment, there is provided an image processing method of a head-up display (HUD) apparatus, the image processing method comprising: obtaining an image; identifying whether a user in the image is wearing sunglasses; tracking an eye of the user using a plurality of types of eye trackers, based on a result of the identifying whether the user is wearing the sunglasses; and outputting information about a face area of the user including a position of the tracked eye.

The tracking the eye of the user may comprise: tracking the eye of the user using a first type eye tracker of the plurality of types of eye trackers, based on identifying that the user is not wearing the sunglasses; and tracking the eye of the user using a second type eye tracker of the plurality of types of eye trackers, based on identifying that the user is wearing the sunglasses.

The first type eye tracker may be configured to track the eye of the user by aligning a first number of points in a shape of a portion of the face area, the second type eye tracker is configured to track the eye of the user by aligning a second number of points in a shape of an entire face area, and the second number is greater than the first number.

The tracking the eye of the user using the first type eye tracker may comprise: reducing a size of a detection box used to detect the face area to correspond to a shape of an eye area and a shape of a nose area in the face area; obtaining a cropped portion comprising the eye area and the nose area by cropping the face area by the detection box reduced in size; and tracking the eye of the user by aligning the first number of points in the cropped portion.

The tracking the eye of the user using the second type eye tracker may comprise: aligning the second number of points in the shape of an entire area of the face area by a detection box used to detect the face area; and estimating a position of a pupil of the user from the face area by the second number of points, to track the eye of the user.

The identifying whether the user is wearing the sunglasses may comprise identifying whether the user is wearing the sunglasses using a detector that is trained in advance to detect whether eyes of the user are covered by the sunglasses.

In accordance with an aspect of an example embodiment, there is provided a non-transitory computer-readable storage medium storing instructions that, are executable by a processor to perform the image processing method.

In accordance with an aspect of an example embodiment, there is provided an image processing apparatus comprising: a sensor configured to obtain an image including a face of a user; and a processor configured to: detect a face area of the user in the image, identify a type of covering on the face area based on whether the covering is present in at least a portion of the face area, track an eye of the user based on the type of the covering, and output information about the face area including a position of the tracked eye.

The processor may be further configured to track the eye of the user by aligning different numbers of points in a shape of at least a portion of the face area based on the type of the covering.

The processor may be further configured to: track the eye of the user by aligning a first number of points in a shape of a first portion of the face area, based on identifying that the type of the covering is a first type; and track the eye of the user by aligning a second number of points in a shape of a second portion of the face area, based on identifying that the type of the covering is one of a second type, a third type, or a fourth type, the second number being greater than the first number.

The image processing apparatus may comprise at least one of a head-up display (HUD) apparatus, a three-dimensional (3D) digital information display (DID), a navigation apparatus, a 3D mobile apparatus, a smartphone, a smart television (TV), and a smart vehicle.

In accordance with an aspect of another example embodiment, there is provided an image processing apparatus comprising: a memory storing one or more instructions; and a processor configured to execute the one or more instructions to: obtain an image; detect a face area of a user in the image; identify whether a covering is present on at least a portion of the face area of the user; obtain first information based on identifying that the covering is not present on the face area of the user; obtain second information based on identifying that the covering is present on at least the portion of the face area of the user; and track an eye of the user using the first information or the second information based on whether the covering is present on at least the portion of the face area of the user.

The first information may comprise a first number of feature points in a shape of a first portion of the face area and the second information comprises a second number of feature points in a shape of a second portion of the face area.

The first information may comprise first features points in the face area of the user and the second information comprises second feature points in the face area of the user.

In accordance with an aspect of another example embodiment, an image processing method comprising: obtaining an image; detecting a face area of a user in the image, identifying whether a covering is present on at least a portion of the face area of the user; obtaining first information based on identifying that the covering is not present on the face area of the user; obtaining second information based on identifying that the covering is present on at least the portion of the face area of the user; and tracking an eye of the user using the first information or the second information based on whether the covering is present on at least the portion of the face area of the user.

The first information may comprise a first number of feature points in a shape of a first portion of the face area and the second information comprise a second number of feature points in a shape of a second portion of the face area.

The first information may comprise first features points in the face area of the user and the second information may comprise second feature points in the face area of the user.

### BRIEF DESCRIPTION OF THE DRAWINGS

The above and/or other aspects will be more apparent by describing certain example embodiments with reference to the accompanying drawings, in which:

FIG. 1 is a flowchart illustrating an example of an image processing method according to an example embodiment;

FIG. 2 is a diagram illustrating a method of classifying a type of covering in a face area according to an example embodiment;

FIG. 3 is a flowchart illustrating a method of tracking an eye of a user based on a type of covering according to an example embodiment;

FIG. 4 is a diagram illustrating a method of aligning different numbers of points based on a type of covering by an image processing apparatus according to an example embodiment;

FIG. 5 is a flowchart illustrating a method of tracking an eye of a user according to an example embodiment;

FIG. 6 is a diagram illustrating another example of an image processing method according to an example embodiment;

FIG. 7 is a flowchart illustrating another example of an image processing method according to an example embodiment; and

FIG. 8 is a block diagram illustrating an image processing apparatus according to an example embodiment.

### DETAILED DESCRIPTION

Hereinafter, example embodiments will be described in detail with reference to the accompanying drawings. Various modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing example embodiments only and is not to be limiting of the example embodiments. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Also, the terms “first,” “second,” “A,” “B,” “(a),” “(b),” and the like may be used herein to describe components according to example embodiments. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

A component having a common function with a component included in one example embodiment is described using a like name in another example embodiment. Unless otherwise described, description made in one example embodiment may be applicable to another example embodiment and detailed description within a duplicate range is omitted.

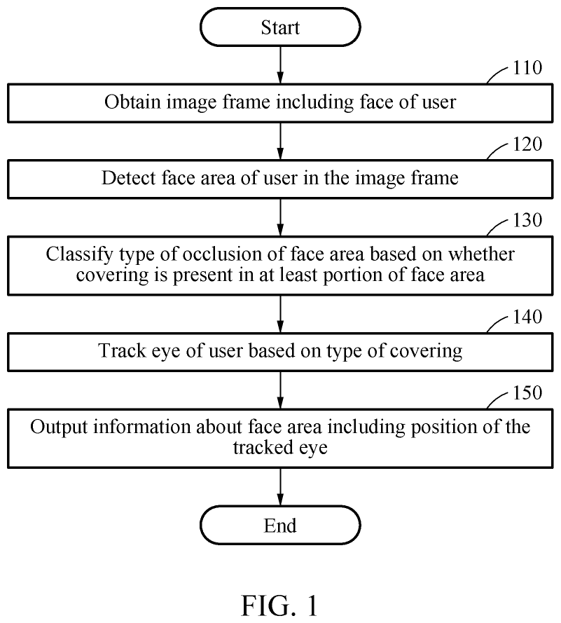

FIG. 1 is a flowchart illustrating an image processing method according to an example embodiment. Referring to FIG. 1, an image processing apparatus may output information about a face area including a position of an eye of a user by performing operations 110 through 150.

Methods and/or apparatuses in one or more example embodiments described below may be used to output coordinates of eyes of a user by tracking the eyes using an infrared camera or an RGB camera when glasses-free three-dimensional (3D) monitor, a glasses-free 3D tablet/smartphone, and 3D head-up display (HUD) are used. Also, one or more of the example embodiments may be implemented in a form of a software algorithm in a chip of a monitor, or an application in a tablet or a smartphone, or implemented as a hardware eye tracking apparatus. Moreover, one or more of the example embodiments may be applicable to an autonomous vehicle, an intelligent vehicle, a smartphone, or a mobile device.

In operation 110, the image processing apparatus obtains an image frame including a face of a user. The image frame may include, for example, a color image frame or an infrared image frame. According to another example embodiment, the image frame may include a color image frame, an infrared image frame, or both a color image frame an infrared image frame. The image frame may correspond to, for example, an image of a driver captured by a vision sensor, an image sensor, or a camera installed in a vehicle.

In operation 120, the image processing apparatus detects a face area of the user in the image frame obtained in operation 110. For example, the image processing apparatus may set a scan area to detect the face area. For example, the image processing apparatus may set a scan area using a detector trained in advance to detect the face area by machine learning, and may detect the face area in the image frame. According to an example embodiment, the detector may be trained to detect a face of a user wearing sunglasses as well as a face (hereinafter, referred to as a “bare face”) of a user who does not wear sunglasses. According to another example embodiment, the detector may be trained to detect a face of a user with a partially covered face area as well as the bare face of a user without any object covering the face. The scan area set by the detector may be represented as, for example, a detection box that will be described below.

According to an example embodiment, when the image frame obtained in operation 110 is an image frame initially obtained by the image processing apparatus, or an initial image frame, the image processing apparatus may detect a face area of a user included in the image frame. According to another example embodiment, when the image frame obtained in operation 110 is not the initial image frame, the image processing apparatus may obtain or receive a face area detected based on one of at least one previous image frame of the image frame. For example, when the image frame is obtained at a time t, the at least one previous frame may be obtained at a previous time (for example, a time t−1, t−2, or t−3) to the time t.

In operation 130, the image processing apparatus classifies a type of the covering on the face area based on whether a covering is present in at least a portion of the face area detected in operation 120. For example, the image processing apparatus may classify the type of covering on the face area using a classifier that is trained in advance to distinguish an area in which the covering is present from the other areas in the face area by machine learning. The type of covering may include, for example, a first type corresponding to a bare face in which the covering is absent, a second type in which at least a portion of at least one of a forehead area, an eyebrow area, and an eye area in the face area of the user is covered by a hat, a third type in which the eye area in the face area is covered by sunglasses, and a fourth type in which at least one of a nose area and a mouth area in the face area is covered by a mask.

According to an example embodiment, when all the eyebrow area, the eye area, the nose area and the mouth area are detected in the face area detected in operation 120, the image processing apparatus may classify the type of covering of the face area as the first type in operation 130. Moreover, when at least a portion of the eye area, the nose area, and the mouth area are detected and when at least a portion of at least one of the forehead area, the eyebrow area and the eye area is not detected in the face area, the image processing apparatus may classify the type of covering as the second type in which eyebrows and/or eyes are covered by a hat. Further, when the nose area and the mouth area are detected and when the eye area is not detected in the face area, image processing apparatus may classify the type of covering as the third type in which eyes are covered by sunglasses. Also, when the eyebrow area and the eye area are detected in the face area and when at least one of the nose area and the mouth area is not detected, the image processing apparatus may classify the type of covering as the fourth type in which a nose and/or a mouth is covered by a mask.

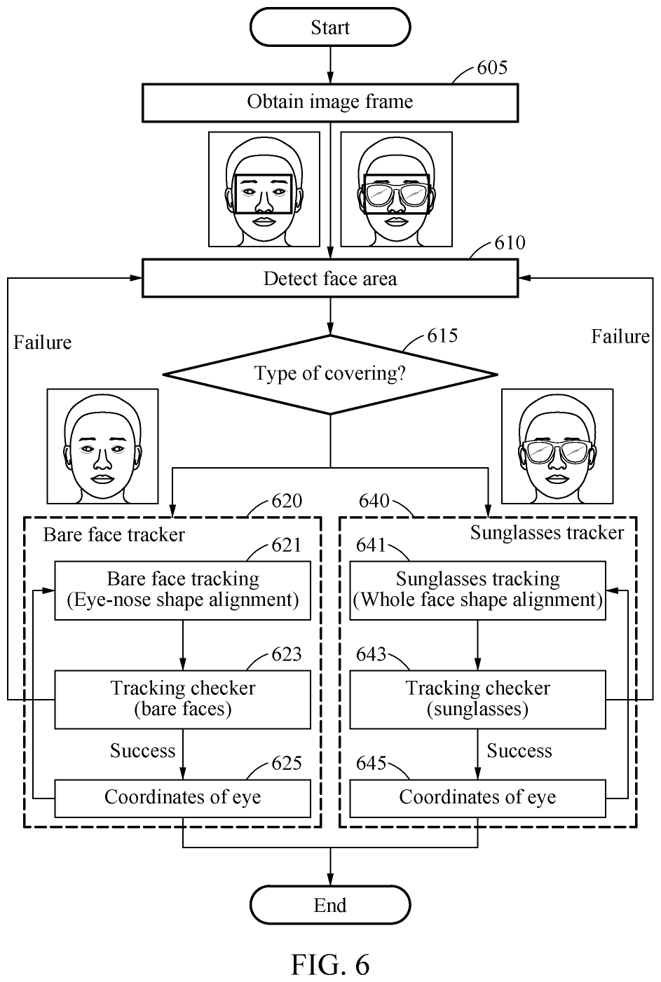

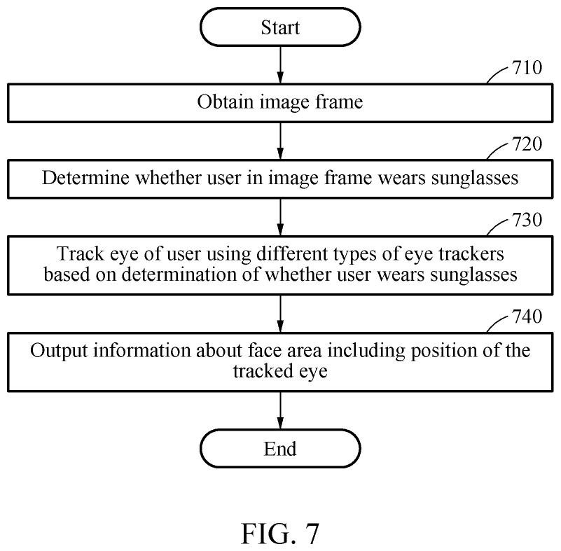

According to example embodiments, the type of the occlusion may be classified into at least one of a type A corresponding to a bare face in which a covering is absent, and a type B in which an eye area is covered by sunglasses in a face area of a user. A method of tracking eyes of a user when the type of covering is classified into the above two types will be further described below with reference to FIGS. 6 and 7.

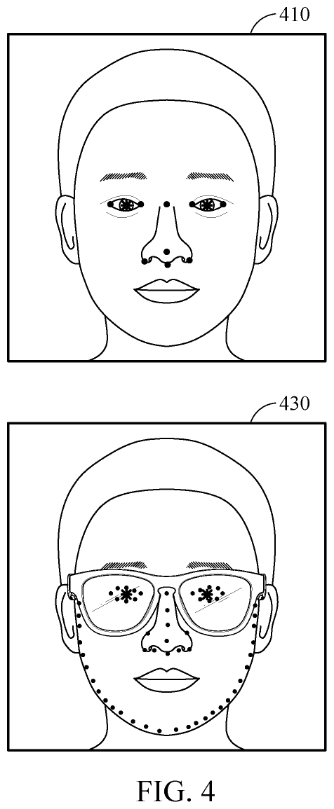

In operation 140, the image processing apparatus tracks an eye of the user based on the type of covering classified in operation 130. For example, when the covering is absent in the face area, the image processing apparatus may identify a central portion of a pupil from the eye of the user based on image features of areas corresponding to a shape of an eye and a nose, and may track the eye of the user based on the identified central portion of the pupil. According to another example embodiment, when the eye of the user is covered by sunglasses or a hat, a method of tracking the eye of the user may vary depending on the type of covering, because it may be impossible to directly track the eye. The image processing apparatus may align different numbers of points in a shape of at least a portion of the face area based on the type of covering classified in operation 130, to track the eye of the user. The image processing apparatus may move different numbers of points to be aligned in a shape of at least a portion of the face area based on image information included in the face area. According to an example embodiment, the “points” may be, for example, feature points corresponding to key points indicating features of a face, for example, an eye, a nose, a mouth or a contour of the face. The points may be indicated as, for example, dots (•) or asterisks (*) as shown in FIG. 4, or in other various forms.

According to an example embodiment, the image processing apparatus may recognize positions of a plurality of feature portions corresponding to eyebrows, eyes, a nose and a mouth of a user from a face area of an image frame using, for example, a supervised descent method (SDM) of aligning points with a shape of an image using a descent vector learned from an initial shape configuration, an active shape model (ASM) scheme of aligning points based on a shape and a principal component analysis (PCA) of the shape, an active appearance model (AAM) scheme, or a constrained local model (CLM) scheme.

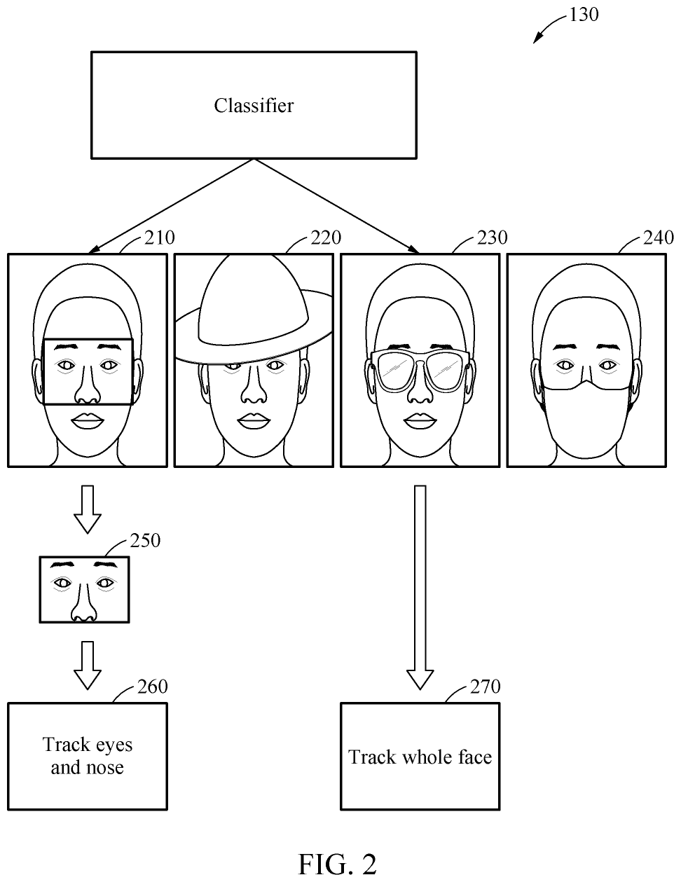

The image processing apparatus may move different numbers of points to be aligned in the recognized positions of the plurality of feature portions, based on the type of covering classified in operation 130. According to an example embodiment, when the image frame is the initial image frame, a plurality of points before being aligned may correspond to average positions of feature portions of a plurality of users. According to another example embodiment, when the image frame is not the initial image frame, the plurality of points before being aligned may correspond to a plurality of points aligned based on a previous image frame. A method by which the image processing apparatus tracks the eye of the user will be further described below with reference to FIGS. 2 through 4.

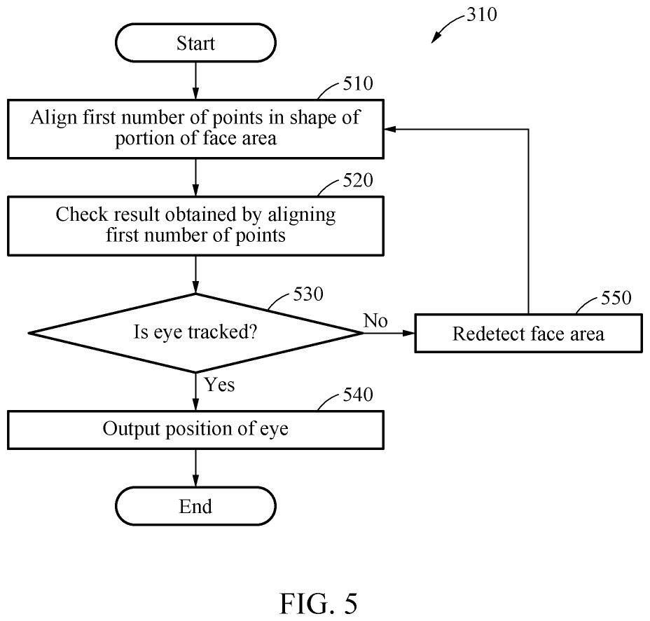

According to an example embodiment, the image processing apparatus may check whether tracking of the eye by the aligned points is successful. Based on a determination that the tracking of the eye fails, the image processing apparatus may redetect the face area, and may repeatedly perform operations 130 and 140 based on the redetected face area so that the eye is successfully tracked. For example, an operation of the image processing apparatus when the tracking of the eye fails will be further described below with reference to FIG. 5.

In operation 150, the image processing apparatus outputs information about the face area including a position of the eye tracked in operation 140. For example, in operation 150, the image processing apparatus may output information about a facial expression of the user and a viewpoint by a position of a pupil, in addition to the position of the pupil or the eye tracked in operation 140. In this example, the information about the face area may include, for example, a position of each of a pupil and a nose included in a scan area, a viewpoint by the position of the pupil, or a facial expression of the user expressed in the scan area. The image processing apparatus may explicitly or implicitly output the information about the face area. According to an example embodiment, “explicitly outputting the information about the face area” may include, for example, displaying a position of a pupil included in the face area and/or a facial expression appearing in the face area on a screen of a display panel, or outputting the position of the pupil and/or the facial expression as audio. According to an example embodiment “implicitly outputting the information about the face area” may include, for example, adjusting an image displayed on a HUD by the position of the pupil included in the face area and a viewpoint by the position of the pupil, or providing a service corresponding to a facial expression appearing in the face area.

In operation 150, the image processing apparatus may reproduce an image corresponding to the position of the eye tracked in operation 140 by performing light field rendering based on the position of the eye tracked in operation 140. According to an example embodiment, when the type of covering classified in operation 130 corresponds to one of the second type, the third type or the fourth type, the image processing apparatus may output an image to which a glow effect for the face area including the position of the eye tracked in operation 140 is applied. For example, when the type of covering is a type in which an eye is covered, such as the second type or the third type, an accuracy in tracking a position of the eye may be reduced. However, the image processing apparatus according to an example embodiment may display 3D content with a relatively low crosstalk for the position of the tracked eye when the type of covering corresponds to the second type or the third type, and may apply the glow effect, thereby increasing the accuracy. The glow effect is a technique that enhances color and contrast, such as enhancing the contrast of the image and increasing the saturation, and can be used to make the image more intense. For example, you can apply a Gaussian Blur filter to the image and adjust the blur intensity to apply a glow effect to the image.

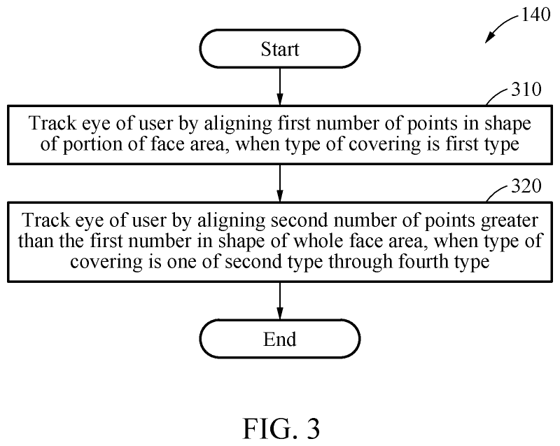

FIG. 2 is a drawing illustrating a method of classifying a type of the covering of a face area according to an example embodiment, and FIG. 3 is a flowchart illustrating a method of tracking an eye of a user based on a type of the covering.

Referring to FIGS. 2 and 3, an image processing apparatus may classify a type of the covering in a face area using a classifier that is trained in advance. For example, the classifier may be a classifier configured to align different numbers of points in a shape of at least a portion of each face area stored in a training image database (DB) based on the type of covering and to learn scale-invariant feature transform (SIFT) features extracted from each of the aligned points. The classifier may include, for example, a support vector machine (SVM) classifier.

For example, the image processing apparatus may classify a type of covering of a face area 210 of a bare face in which covering is absent as a first type. The image processing apparatus may classify a type of the covering of a face area 220 in which at least a portion of at least one of a forehead area, an eyebrow area and an eye area is covered by a hat as a second type. The image processing apparatus may classify a type of covering of a face area 230 in which an eye area is covered by sunglasses as a third type. Also, the image processing apparatus may classify a type of the covering of a face area 240 in which a mouth area or both the mouth area and a nose area are covered by a mask as a fourth type.

When the type of the covering is the first type, the image processing apparatus may align a first number of points in a shape of a portion of the face area 210 and may track an eye of a user as in operation 310. For example, when the type of the occlusion is the first type, the image processing apparatus may reduce a size of a detection box used to detect a face area to correspond to a shape of an eye area and a shape of a nose area in the face area, as shown in a detection box 250. The image processing apparatus may obtain a cropped portion including the eye area and the nose area by cropping the face area 210 by the reduced detection box 250. The image processing apparatus may align the first number of points (for example, “11” points) in the shape of the eye area and the shape of the nose area in the cropped portion, and may track eyes and a nose of the user in operation 260. A method by which the image processing apparatus aligns the first number of points will be further described below with reference to an image 410 of FIG. 4.

Referring to FIG. 3, in operation 310, the image processing apparatus may track the eye of the user by checking an alignment result of the face area corresponding to the eyes and the nose of the user using the “11” points. The image processing apparatus may check the alignment result of the face area corresponding to the eyes and the nose in a scan area, based on image information in the scan area by the detection box 250. The image processing apparatus may determine whether a scan area corresponds to an eye and a nose using a checker based on SIFT features. The “SIFT features” may be obtained by two operations that are described below. For example, the image processing apparatus may extract candidate points corresponding to the maximum brightness or the minimum brightness of an image in a scale space by an image pyramid from image data of the scan area, and may select points to be used in image registration by filtering points with a relatively low contrast range. The image processing apparatus may obtain a direction component through a gradient of a surrounding area based on the selected points, may reset a region of interest (ROI) based on the obtained direction component, may detect a size of a point, and may generate a describer. In this example, the describer may correspond to an SIFT feature.

For example, when the type of covering is classified as the first type, the image processing apparatus may include a separate module that is configured to align the first number of points in the shape of the eye area and the shape of the nose area in the cropped portion by the reduced detection box 250 and to track the eyes and the nose of the user, and the module may be referred to as a “bare face tracker”.

When the type of the occlusion is one of the second type, the third type or the fourth type, the image processing apparatus may align a second number of points in a shape of the whole face image and may track the eyes of the user, as in operation 320. The second number of points may be greater than the first number of points.

In operation 320, the image processing apparatus may align the second number of points (for example, “98” points) in the shape of the whole face image by a detection box used to detect the face area, and may estimate a position of a pupil of the user in the face area by the second number of the aligned points. When the type of covering is one of the second type, the third type or the fourth type, the image processing apparatus may track a whole face in operation 270. A method by which the image processing apparatus aligns the second number of points will be further described below with reference to an image 430 of FIG. 4.

For example, when the type of covering is classified as the third type, the image processing apparatus may include a separate module that is configured to align the second number of points in the shape of the whole face area and to estimate the position of the pupil of the user in the face area by the second number of the aligned points, and the module may be referred to as a “sunglasses tracker”.

FIG. 4 is a diagram illustrating a method of aligning different numbers of points based on a type of covering by an image processing apparatus according to an example embodiment. In FIG. 4, the image 410 shows points aligned when the type of the occlusion is classified as a first type, and the image 430 shows points aligned when the type of the occlusion is classified as a third type. Hereinafter, a method of aligning points based on the third type, among the second type, the third type and the fourth type is illustrated for convenience of description, however, points may be aligned similarly to the third type, even when the type of covering is the second type or the fourth type. According to another example embodiment, the number of points and the alignment of the points may be different for each of the second type, the third type and the fourth type.

In an example embodiment, when the type of covering is classified as the first type, the image processing apparatus may align a first number of points (for example, “11” points) in a shape of a partial area corresponding to an eye and a nose in a face area as shown in the image 410, and may track eyes of a user. In this example, the “11” points may correspond to, but are not limited to, three points corresponding a right eye, three points corresponding to a left eye, one point corresponding to a middle of the forehead, and four points corresponding to a tip and a contour of the nose.

In another example embodiment, when the type of covering is classified as the third type, the image processing apparatus may align a second number of points (for example, “98” points) in a shape of the whole face area as shown in the image 430, and may track the eyes of the user. In this example, the “98” points may correspond to, but are not limited to, “19” points corresponding to a shape of a right eyebrow and a right eye of the user, “19” points corresponding to a shape of a left eyebrow and a left eye of the user, “12” points corresponding to a shape of a nose, “15” points corresponding to a shape of a mouth, and “33” points corresponding to a shape of a contour line of a face. The image processing apparatus may estimate a position of a pupil of the user in the face area by the aligned “98” points, to track the eyes of the user.

FIG. 5 is a flowchart illustrating a method of tracking an eye of a user according to an example embodiment. Referring to FIG. 5, when tracking of an eye of a user fails, an image processing apparatus may redetect a face area through operations 510, 520, 530, 540 and 550, so that the eye of the user may be successfully tracked.

Although a method of tracking an eye when the type of the occlusion is classified as the first type is described for convenience of description, the method may also be applicable to an example in which the type of the occlusion is classified as one of the second type, the third type or the fourth type.

In operation 510, the image processing apparatus aligns a first number of points in a shape of a portion of a face area in an image frame. For example, the image processing apparatus may recognize a position corresponding to a shape of an eye and a nose of the user from the face area, and may move the first number of points to be aligned in the recognized position.

In operation 520, the image processing apparatus checks a result obtained by aligning the first number of points in operation 510. The image processing apparatus may determine whether an area in which points are aligned corresponds to an actual eye and/or a nose based on image information in an eye area and/or a nose area in the image frame.

In operation 530, the image processing apparatus determines whether the eye of the user is tracked based on the result checked in operation 520.

When the tracking of the eye of the user is successful in operation 530, the image processing apparatus outputs a position of the eye in operation 540. The position of the eye may correspond to, for example, eye position coordinates in two-dimensional (2D), or eye position coordinates in 3D.

When the tracking of the eye of the user fails in operation 530, the image processing apparatus redetects the face area from the image frame in operation 550. The image processing apparatus may perform operations 510 through 530 on the face area redetected in operation 550 to track the eye.

FIG. 6 is a diagram illustrating another example of an image processing method according to an example embodiment. FIG. 6 illustrates a process by which an image processing apparatus outputs coordinates of an eye based on a type of covering using a bare face tracker 620 and a sunglasses tracker 640.

In operation 605, the image processing apparatus obtains an image frame.

In operation 610, the image processing apparatus detects a face area of a user in the image frame obtained in operation 605. For example, the image processing apparatus may detect a whole face area by a scan window or a detection box used to set a scan area in the image frame. According to an example embodiments, the image processing apparatus may detect an area corresponding to sunglasses or areas corresponding to an eye and a nose in a face by the detection box or the scan window.

In operation 615, the image processing apparatus classifies a type of covering of the face area detected in operation 610.

In an example embodiment, it is assumed that the face area detected in operation 610 corresponds to a bare face and the type of the occlusion is classified as a first type in operation 615. In this example, the image processing apparatus may track an eye from the bare face and output coordinates of the eye by performing operations 621, 623 and 625 using the bare face tracker 620.

In operation 621, the image processing apparatus aligns a first number of points (for example, “11” points) in a shape of a cropped portion including an eye area and a nose area by cropping the face image, by the reduced detection box and may track eyes and a nose of the user.

In operation 623, the image processing apparatus may check whether the eyes or both the eyes and the nose are properly tracked by SIFT features corresponding to the “11” points used in operation. In operation 623, the image processing apparatus may check whether the eyes are properly tracked by assigning a relatively high weight to the eyes in comparison to the nose among the SIFT features. The image processing apparatus may perform the checking using the above-described SVM.

When it is verified that the eyes are properly tracked in operation 623, the image processing apparatus may output coordinates of the eyes corresponding to positions of the tracked eyes in operation 625. When it is verified that the eyes are not properly tracked in operation 623, the image processing apparatus may redetect the face area in operation 610. The image processing apparatus may reclassify a type of an occlusion in the redetected face area and may track the eyes.

In another example, it is assumed that the face area detected in operation 610 corresponds to a face in which eyes are occluded by sunglasses and the type of the occlusion is classified as a third type in operation 615. In this example, the image processing apparatus may track positions of eyes on a face wearing sunglasses and output coordinates of the eyes by performing operations 641, 643 and 645 using the sunglasses tracker 640.

In operation 641, the image processing apparatus aligns a second number of points (for example, “98” points) in a shape of the whole face area, and estimates positions of pupils from the face area by the second number of the aligned points, to track eyes of the user. In operation 641, the image processing apparatus may estimate positions of the eyes, for example, pupils, of the user through machine learning using a DB that includes a large number of images. In this example, the image processing apparatus may enhance an accuracy by assigning a weight to the estimated positions of the eyes of the user.

In operation 643, the image processing apparatus may check whether the positions of the eyes or the pupils of the user estimated using the second number of points in operation 641 are correct. For example, in operation 643, the image processing apparatus may check whether the positions of the eyes or the pupils of the user are correct, based on points other than points corresponding to the sunglasses, that is, points corresponding to areas other than an area corresponding to the sunglasses.

When it is verified that the positions of the eyes or the pupils of the user are correct in operation 643, the image processing apparatus may output coordinates of the eyes based on the estimated positions of the eyes in operation 645. When it is verified that the positions of the eyes or the pupils of the user are incorrect in operation 643, the image processing apparatus may redetect the face area in operation 610. The image processing apparatus may reclassify a type of an occlusion in the redetected face area and may track the eyes of the user.

FIG. 7 is a flowchart illustrating another example of an image processing method according to an example embodiment. FIG. 7 illustrates a process by which a 3D HUD apparatus of a vehicle that is an example of an image processing apparatus tracks an eye of a user and outputs a tracking result through operations 710, 720, 730 and 740.

In operation 710, the HUD apparatus obtains an image frame. The image frame may correspond to, for example, a color image frame or an infrared image frame.

In operation 720, the HUD apparatus determines whether a user in the image frame wears sunglasses. For example, the HUD apparatus may determine whether the user wears the sunglasses using a detector that is trained in advance to detect whether an eye area of the user is occluded by the sunglasses.

In operation 730, the HUD apparatus tracks an eye of the user using different types of eye trackers, based on a determination of whether the user wears sunglasses in operation 720.

In an example, based on a determination that the user does not wear the sunglasses in operation 720, the HUD apparatus may track the eye of the user using a first type eye tracker. The first type eye tracker may be configured to track the eye of the user by aligning a first number of points in a shape of a portion of a face area of the user.

In this example, based on the determination that the user does not wear the sunglasses in operation 720, the HUD apparatus may reduce a size of a detection box used to detect the face area of the user to correspond to a shape of an eye area and a shape of a nose area in the face area, using the first type eye tracker in operation 730. The HUD apparatus may obtain a cropped portion including the eye area and the nose area by cropping the face area, by the detection box reduced in size by the first type eye tracker, and may track the eye of the user by aligning the first number of points in the cropped portion.

In another example, based on a determination that the user wears the sunglasses in operation 720, the HUD apparatus may track the eye of the user using a second type eye tracker. The second type eye tracker may be configured to track the eye of the user by aligning a second number of points in a shape of a whole face area of the user, and the second number may be greater than the first number.

In this example, based on the determination that the user wears the sunglasses in operation 720, the HUD apparatus may align the second number of points in the shape of the whole face area by a detection box used to detect the face area of the user, using the second type eye tracker in operation 730. The HUD apparatus may estimate a position of a pupil of the user from the face area by the second number of the aligned points, to track the eye of the user.

In operation 740, the HUD apparatus outputs information about the face area including a position of the tracked eye.

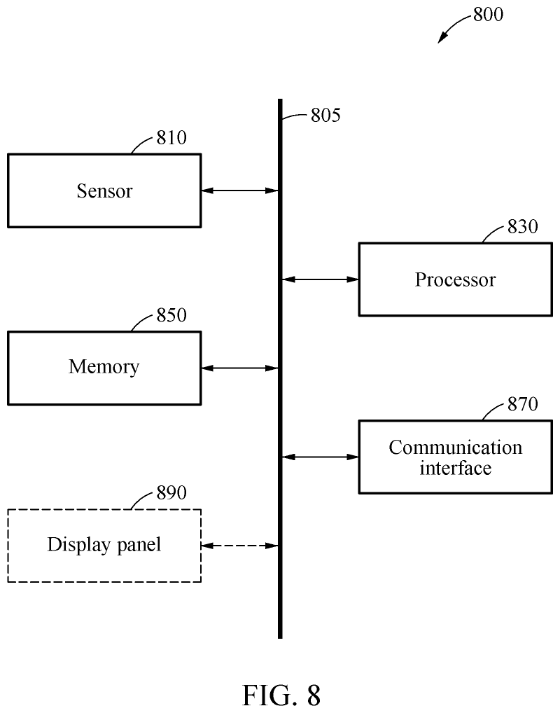

FIG. 8 is a block diagram illustrating an image processing apparatus according to an example embodiment. Referring to FIG. 8, an image processing apparatus 800 include a sensor 810 and a processor 830. The image processing apparatus 800 may further include a memory 850, a communication interface 870, and a display panel 890. The sensor 810, the processor 830, the memory 850, the communication interface 870, and the display panel 890 may communicate with each other via a communication bus 805. However, the disclosure is not limited to the arrangement of the components illustrated in FIG. 8. For instance, according to another example embodiment, an image processing apparatus may not include all of the components illustrated in FIG. 8 or an image processing apparatus may include other components in addition to the components illustrated in FIG. 8.

The sensor 810 may obtain an image frame including a face of a user. The sensor 810 may include, for example, an image sensor configured to capture an input image by an infrared lighting, a vision sensor, or an infrared camera. The image frame may include, for example, a face image of a user, or an image of a user who is driving a vehicle.

The processor 830 may detect a face area of a user in the image frame. For example, the image frame may be obtained by the sensor 810, or may be received from a component or a device external to the image processing apparatus 800 via the communication interface 870.

The processor 830 may classify a type of covering of the face area based on whether the covering is present in at least a portion of the face area. The processor 830 may track an eye of the user based on the type of covering. The processor 830 may output information about the face area including a position of the tracked eye.

For example, the processor 830 may display the information about the face area including the position of the tracked eye on the display panel 890, or may output the information about the face area to the outside of the image processing apparatus 800 via the communication interface 870.

According to an example embodiment, the processor may be a single processor 830. According to another example embodiment, the processor 830 may be implemented by a plurality of processors. The processor 830 may perform one or more the methods described with reference to FIGS. 1 through 7, or an algorithm corresponding to one or more of the methods. The processor 830 may execute a program and may control the image processing apparatus 800. A program code executed by the processor 830 may be stored in the memory 850. The processor 830 may include, for example, a central processing unit (CPU), a graphics processing unit (GPU), or a neural network processing unit (NPU).

The memory 850 may store the image frame obtained by the sensor 810, the face area detected in the image frame by the processor 830, the type of covering of the face area classified by the processor 830, and coordinates of the eye of the user tracked by the processor 830. Also, the memory 850 may store the information about the face area output by the processor 830. The memory 850 may be, for example, a volatile memory, or a non-volatile memory.

The communication interface 870 may receive an image frame from a component or a device external to the image processing apparatus 800. The communication interface 870 may output the face area detected by the processor 830 and/or the information about the face area including the position of the eye tracked by the processor 830. The communication interface 870 may receive an image frame captured outside the image processing apparatus 800, or information obtained by various sensors from outside of the image processing apparatus 800.

The display panel 890 may display a processing result of the processor 830, for example, the information about the face area including the position of the eye tracked by the processor 830. For example, when the image processing apparatus 800 is embedded in a vehicle, the display panel 890 may be configured as a HUD installed in the vehicle.

The image processing apparatus 800 may include, but is not limited to, for example, a HUD apparatus, a 3D digital information display (DID), a navigation apparatus, a 3D mobile apparatus, a smartphone, a smart television (TV), or a smart vehicle. The 3D mobile apparatus may be understood to include, for example, a display apparatus configured to display augmented reality (AR), virtual reality (VR), and/or mixed reality (MR), a head-mounted display (HMD), and a face-mounted display (FMD).

The methods according to the above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described example embodiments, or vice versa.

Software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

While this disclosure includes example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An image processing method comprising:
obtaining an image including a face of a user;
detecting a face area of the user in the image;
identifying a type of covering on the face area based on whether the covering is present in at least a portion of the face area;
tracking an eye of the user based on the type of the covering; and
outputting information about the face area including a position of the tracked eye.

2. The image processing method of claim 1, wherein the type of the covering comprises at least one of:
a first type corresponding to a bare face in which the covering is not present;
a second type in which at least a portion of at least one of a forehead area, an eyebrow area, and an eye area in the face area is covered;
a third type in which the eye area in the face area is covered; and
a fourth type in which at least one of a nose area and a mouth area in the face area is covered.

3. The image processing method of claim 1, wherein the type of the covering comprises at least one of:
a first type corresponding to a bare face in which the covering is not present; and
a second type in which an eye area in the face area is covered by sunglasses.

4. The image processing method of claim 1, wherein the tracking the eye of the user comprises tracking the eye of the user by aligning different numbers of points in a shape of at least a portion of the face area based on the type of the covering.

5. The image processing method of claim 2, wherein the tracking the eye of the user comprises:
tracking the eye of the user by aligning a first number of points in a shape of a first portion of the face area, based on identifying that the type of the covering is the first type; and
tracking the eye of the user by aligning a second number of points in a shape of a second portion of the face area, based on identifying that the type of the covering is one of the second type, the third type, or the fourth type, the second number being greater than the first number.

6. The image processing method of claim 5, wherein the tracking the eye of the user based on identifying that the type of the covering is the first type comprises:
reducing a size of a detection box used to detect the face area to correspond to a shape of an eye area and a shape of a nose area in the face area;
obtaining a cropped portion comprising the eye area and the nose area by cropping the face area by the detection box reduced in size; and
aligning the first number of points in the cropped portion, to track the eye of the user.

7. The image processing method of claim 5, wherein the tracking the eye of the user based on identifying the type of the covering is one of the second type, the third type, or the fourth type comprises:
aligning the second number of points in the shape of the second portion, which is an entire area of the face area, by a detection box used to detect the face area; and
estimating a position of a pupil of the user from the face area by the second number of points, to track the eye of the user.

8. The image processing method of claim 4, wherein the tracking the eye of the user comprises:
redetecting the face area based on a failure in the tracking of the eye of the user using the aligned points; and
repeatedly performing the identifying of the type of the covering and the tracking of the eye of the user, based on the redetected face area.

9. The image processing method of claim 1, wherein the identifying the type of the covering comprises identifying the type of the covering using a classifier that is trained in advance to distinguish an area in which the covering is present from other areas in the face area by machine learning.

10. An image processing method of a head-up display (HUD) apparatus, the image processing method comprising:
obtaining an image;
identifying whether a user in the image is wearing sunglasses;
tracking an eye of the user using a plurality of types of eye trackers, based on a result of the identifying whether the user is wearing the sunglasses; and
outputting information about a face area of the user including a position of the tracked eye.

11. The image processing method of claim 10, wherein the tracking the eye of the user comprises:
tracking the eye of the user using a first type eye tracker of the plurality of types of eye trackers, based on identifying that the user is not wearing the sunglasses; and
tracking the eye of the user using a second type eye tracker of the plurality of types of eye trackers, based on identifying that the user is wearing the sunglasses.

12. The image processing method of claim 11, wherein the first type eye tracker is configured to track the eye of the user by aligning a first number of points in a shape of a portion of the face area,
the second type eye tracker is configured to track the eye of the user by aligning a second number of points in a shape of an entire face area, and
the second number is greater than the first number.

13. The image processing method of claim 12, wherein the tracking the eye of the user using the first type eye tracker comprises:
reducing a size of a detection box used to detect the face area to correspond to a shape of an eye area and a shape of a nose area in the face area;
obtaining a cropped portion comprising the eye area and the nose area by cropping the face area by the detection box reduced in size; and
tracking the eye of the user by aligning the first number of points in the cropped portion.

14. The image processing method of claim 11, wherein the tracking the eye of the user using the second type eye tracker comprises:
aligning the second number of points in the shape of an entire area of the face area by a detection box used to detect the face area; and
estimating a position of a pupil of the user from the face area by the second number of points, to track the eye of the user.

15. The image processing method of claim 10, wherein the identifying whether the user is wearing the sunglasses comprises identifying whether the user is wearing the sunglasses using a detector that is trained in advance to detect whether eyes of the user are covered by the sunglasses.

16. A non-transitory computer-readable storage medium storing instructions that, are executable by a processor to perform the image processing method of claim 1.

17. An image processing apparatus comprising:
a sensor configured to obtain an image including a face of a user; and
a processor configured to:
detect a face area of the user in the image,
identify a type of covering on the face area based on whether the covering is present in at least a portion of the face area,
track an eye of the user based on the type of the covering, and
output information about the face area including a position of the tracked eye.

18. The image processing apparatus of claim 17, wherein the processor is further configured to track the eye of the user by aligning different numbers of points in a shape of at least a portion of the face area based on the type of the covering.

19. The image processing apparatus of claim 18, wherein the processor is further configured to:
track the eye of the user by aligning a first number of points in a shape of a first portion of the face area, based on identifying that the type of the covering is a first type; and
track the eye of the user by aligning a second number of points in a shape of a second portion of the face area, based on identifying that the type of the covering is one of a second type, a third type, or a fourth type, the second number being greater than the first number.

20. The image processing apparatus of claim 17, wherein the image processing apparatus comprises at least one of a head-up display (HUD) apparatus, a three-dimensional (3D) digital information display (DID), a navigation apparatus, a 3D mobile apparatus, a smartphone, a smart television (TV), and a smart vehicle.

21. An image processing apparatus comprising:
a memory storing one or more instructions; and
a processor configured to execute the one or more instructions to:
obtain an image;
detect a face area of a user in the image;
identify whether a covering is present on at least a portion of the face area of the user;
obtain first information based on identifying that the covering is not present on the face area of the user;
obtain second information based on identifying that the covering is present on at least the portion of the face area of the user; and
track an eye of the user using the first information or the second information based on whether the covering is present on at least the portion of the face area of the user.

22. The image processing apparatus of claim 21, wherein the first information comprises a first number of feature points in a shape of a first portion of the face area and the second information comprises a second number of feature points in a shape of a second portion of the face area.

23. The image processing apparatus of claim 21, wherein the first information comprises first features points in the face area of the user and the second information comprises second feature points in the face area of the user.

24. An image processing method comprising:
obtaining an image;
detecting a face area of a user in the image,
identifying whether a covering is present on at least a portion of the face area of the user;
obtaining first information based on identifying that the covering is not present on the face area of the user;
obtaining second information based on identifying that the covering is present on at least the portion of the face area of the user; and
tracking an eye of the user using the first information or the second information based on whether the covering is present on at least the portion of the face area of the user.

25. The image processing method of claim 24, wherein the first information comprises a first number of feature points in a shape of a first portion of the face area and the second information comprises a second number of feature points in a shape of a second portion of the face area.

26. The image processing method of claim 24, wherein the first information comprises first features points in the face area of the user and the second information comprises second feature points in the face area of the user.
